(19) United States
(12) Patent Application Publication
(10) Pub. No.: US 2016/0082908 A1
(43) Pub. Date: Mar. 24, 2016

(54) ELECTRONIC CONTROL APPARATUS

(71) Applicant: HITACHI AUTOMOTIVE SYSTEMS, LTD., Ibaraki (JP)

(72) Inventors: Kazuhiko NAKANO, Isesaki-shi (JP); Kiminori MUTO, Isesaki-shi (JP); Daisuke YASUKAWA, Isesaki-shi (JP); Hirofumi WATANABE, Isesaki-shi (JP)

(73) Assignee: HITACHI AUTOMOTIVE SYSTEMS, LTD., Ibaraki (JP)

(21) Appl. No.: 14/847,809

(22) Filed: Sep. 8, 2015

(30) Foreign Application Priority Data
Sep. 22, 2014 (JP) 2014-192081

(51) Int. Cl. B60R 16/03; B62D 5/04

(52) U.S. Cl. CPC B60R 16/03; B62D 5/0406

(57) ABSTRACT

An electronic control apparatus includes an electric motor including a rotor and a stator; a circuit board configured to drivingly control the electric motor; and a housing unit accommodating the electric motor and the circuit board. A vehicle-body attaching portion of the housing unit is attached and fixed to a vehicle body. The vehicle-body attaching portion is located on one side of the rotor with respect to an extending direction of the rotor. At least one of both surfaces of the circuit board is a component-mounting surface. The circuit board is fixed to the housing unit in a state where the both surface of the circuit board extend along the rotor of the electric motor. A large-size electronic component is mounted on a vehicle-body-attaching-portion-side portion of a peripheral portion of the component-mounting surface which is close to the vehicle-body attaching portion.

### BACKGROUND OF THE INVENTION

The present invention relates to an electronic control apparatus.

An electronic control apparatus mounted in a vehicle, such as an electric power steering apparatus and a brake control apparatus, includes a housing unit that accommodates an electric motor and a control unit. The control unit includes a circuit board which drivingly controls the electric motor. Such an electronic control apparatus is attached to a desired location (of an engine room or the like) in the vehicle.

Various electronic components are mounted on a component-mounting surface of the circuit board. For example, a drive element (such as a semiconductor switching element) for the electric motor, a heat-generating electronic component such as an arithmetic processing unit (CPU), a large-size electronic component such as an electrolytic condenser for the drive element, and a small-size electronic component such as a resistor and a chip can be listed. Recently, a high powered output (high current output) of the electronic control apparatus is needed depending on a targeted vehicle. Hence, the electronic components of the circuit board are added and/or grow in size as needed.

The electronic control apparatus sometimes vibrates due to a drive of the electric motor, a vehicle running and the like. As a countermeasure against these vibrations, Japanese Patent Application Publication No. 2011-162000 (Patent literature 1) discloses that the housing unit is provided with a vibration damping section in order to suppress vibrations of the housing unit.

### SUMMARY OF THE INVENTION

The above-mentioned vibrations are able to transmit to the housing unit and also to the circuit board of the electronic control unit. Hence, there is a risk that an large-size electronic component which is relatively large in height and/or weight among electronic components mounted on the circuit board is easily swung and thereby damaged, e.g. detached from the circuit board.

It is therefore an object of the present invention to provide an electronic control apparatus devised to suppress the swings of the electronic component.

According to one aspect of the present invention, there is provided an electronic control apparatus comprising: an electric motor including a rotor and a stator; a circuit board configured to drivingly control the electric motor; and a housing unit accommodating the electric motor and the circuit board, wherein a vehicle-body attaching portion of the housing unit is attached and fixed to a vehicle body, the vehicle-body attaching portion being located on one side of the rotor with respect to an extending direction of the rotor, at least one of both surfaces of the circuit board is a component-mounting surface, the circuit board is fixed to the housing unit in a state where the both surface of the circuit board extend along the rotor of the electric motor, and a large-size electronic component is mounted on a vehicle-body-attaching-portion-side portion of a peripheral portion of the component-mounting surface which is close to the vehicle-body attaching portion.

The other objects and features of this invention will become understood from the following description with reference to the accompanying drawings.

### BRIEF DESCRIPTION OF DRAWINGS

FIG. 1 is an oblique perspective view showing one example of a brake control apparatus in an embodiment according to the present invention.

FIG. 2 is a plan view of the brake control apparatus of FIG. 1, as viewed from a ceiling.

FIG. 3 is a partially-exploded plan view of the brake control apparatus of FIG. 1, as viewed from a ground.

FIG. 4 is a cross-sectional view of a part of the brake control apparatus, taken along a line X-X of FIG. 2.

FIG. 5 is a schematic explanatory view of a circuit board 8 as viewed from a side of a component-mounting surface 80b.

FIG. 6 is a schematic cross-sectional view of FIG. 5, taken in a ceiling-ground direction.

### DETAILED DESCRIPTION OF THE INVENTION

Hereinafter, embodiments according to the present invention will be explained in detail with reference to the drawings. An electronic control apparatus in an embodiment according to the present invention suppresses swings (oscillations) of a large-size electronic component such as an electrolytic condenser which is mounted on a circuit board (circuit substrate).

In the technique as shown in Patent Literature 1, a housing unit is provided with a vibration damping section as a means of preventing swings of the large-size electronic component. As the other technique, it is conceivable that an outer circumferential side of the electronic component which is able to swing is coated and fastened by adhesive or the like in order to suppress the swings. However, in this case, a cost increase is incurred. Moreover, in the case of electrolytic condenser, a head top portion of the electrolytic condenser includes an explosion-proof valve, and hence, the adhesive coating of the head top portion is unfavorable.

Contrary to the conventional technique in which the adhesive is simply used, the large-size electronic component is mounted on a part of a peripheral portion of a component-mounting surface of the circuit board which is close to a vehicle-body attaching portion in this embodiment. Hence, the swings (oscillations) of the large-size electronic component can be suppressed without using the above-mentioned adhesive. The cost increase is also suppressed.

As mentioned above, the electronic control apparatus according to this embodiment can suppress the swings of the large-size electronic component by mounting the large-size electronic component on the vehicle-body-attaching-portion-side part of the peripheral portion of the component-mounting surface of the circuit board. The electronic control apparatus according to this embodiment can be varied or modified as needed, for example, by employing known techniques in various fields such as an electronic control apparatus of a brake system for automotive vehicle and a housing molding. As one example, the electronic control apparatus according to this embodiment is applied to a brake control apparatus as explained below. In the drawings referred to in the following examples, “ceiling”, “ground”, “front” and “rear” shown by arrows represent directions relative to the brake control apparatus, and respectively represent a ceiling direction, a ground direction, a frontward direction and a rearward direction of the vehicle assuming that the brake control apparatus is installed in an engine room of the vehicle.

<One Example of Electronic Control Apparatus>

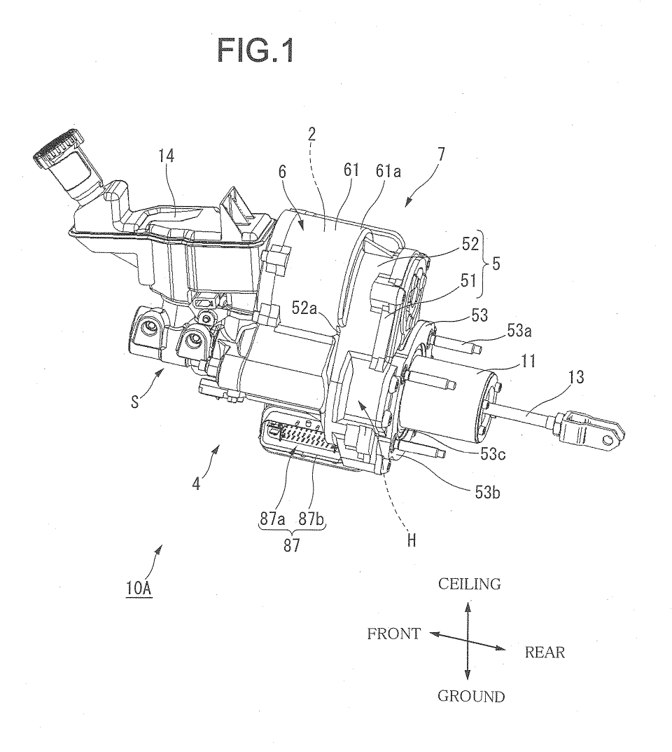

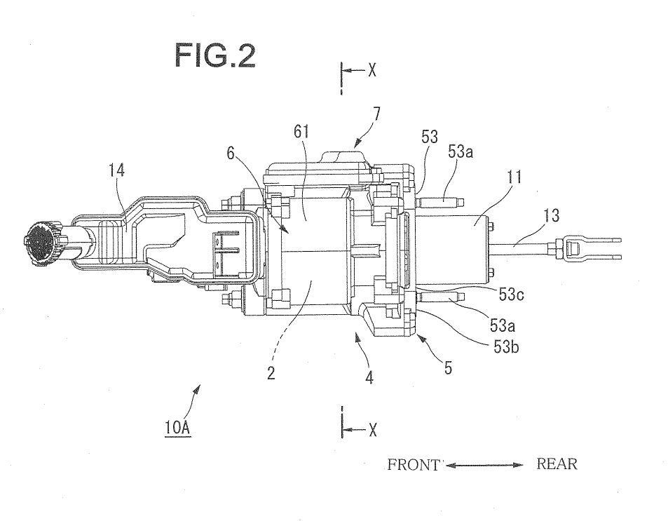

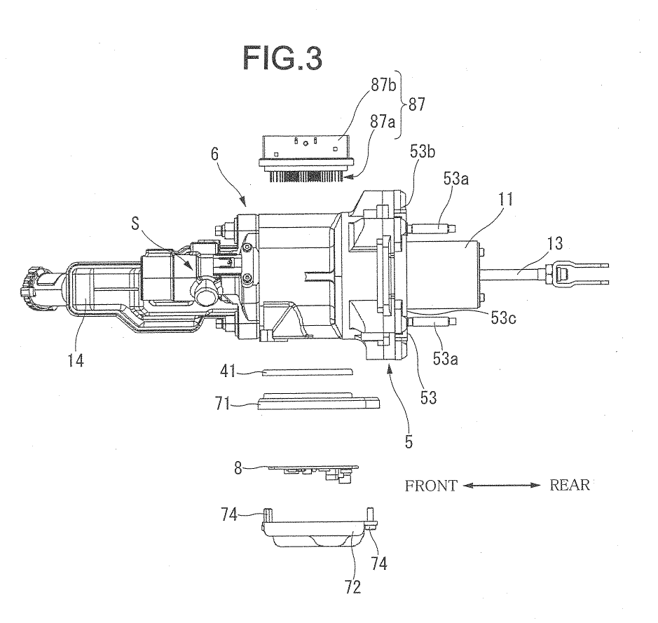

The electronic control apparatus 10A shown in FIGS. 1 to 5 is one example of a brake control apparatus applied to a brake system. This brake system is, for example, mounted in an engine room of a vehicle. The electronic control apparatus 10A mainly includes a master cylinder S, a motor 2, a torque conversion mechanism H, and a control unit 3. The master cylinder S, the motor 2, the torque conversion mechanism H, and the control unit 3 are accommodated in or received by a housing unit 4 which includes a plurality of accommodating portions (i.e., a vehicle-body attaching portion 5, a motor accommodating portion 6 and a control-unit accommodating portion 7 that are shown in FIGS. 1 to 4 and that will be explained below). The master cylinder S extends in a frontward direction from a brake pedal (not shown) to the engine room. For example, the master cylinder S extends to pass through the vehicle-body attaching portion 5 and a vehicle-body panel 90 formed between the brake pedal and the engine room. The master cylinder S encloses a piston 12 which generates brake fluid pressure by an manipulation of the brake pedal. The motor 2 includes a rotor 2a and a stator 2b provided at an outer peripheral side of the rotor 2a. The torque conversion mechanism H converts a torque generated by the motor 2, into a thrust force of the piston 12. The control unit 3 includes a circuit board 8 on which a drive element(s) for drivingly controlling the motor 2 are mounted. Details about the circuit board 8 and the drive element(s) will be mentioned below.

The housing unit 4 includes the vehicle-body attaching portion 5. The vehicle-body attaching portion 5 is attached and fixed to (an attachment surface 90a of) the vehicle-body panel 90, and encloses or accommodates the torque conversion mechanism H. The motor accommodating portion 6 which accommodates the motor 2 and the control-unit accommodating portion 7 which accommodates the control unit 3 are provided to protrude from the vehicle-body attaching portion 5 in the frontward direction. The housing unit 4 is formed by integrating the vehicle-body attaching portion 5, the motor accommodating portion 6 and the control-unit accommodating portion 7 with one another.

As mentioned above, the housing unit 4 has only to include the vehicle-body attaching portion 5, the motor accommodating portion 6 and the control-unit accommodating portion 7 or the like. In this embodiment, a manufacturing method of the housing unit 4 is not limited. For example, the vehicle-body attaching portion 5, the motor accommodating portion 6 and the control-unit accommodating portion 7 are molded by appropriately using known metal material(s) and/or resin material(s), and then, the vehicle-body attaching portion 5, the motor accommodating portion 6 and the control-unit accommodating portion 7 are integrated (combined) with one another and thereby assembled into the housing unit 4. In the case that the vehicle-body attaching portion 5, the motor accommodating portion 6 and the control-unit accommodating portion 7 are made of resin material(s), advantageous effects of a manufacturing-cost reduction and a weight reduction are achieved.

The vehicle-body attaching portion 5 of the housing unit 4 includes a bottom wall 51 and a peripheral wall 52. The bottom wall 51 is substantially in the form of rectangle, and encloses the torque conversion mechanism H which transmits and converts the torque generated by the motor 2 into the thrust force of the piston 12. The peripheral wall 52 protrudes to surround four sides of the substantially-rectangular bottom wall 51 (In the case of FIGS. 1 to 4, the peripheral wall 52 protrudes in the frontward direction). The peripheral wall 52 is formed with an opening portion 52a which opens in a protruding direction of the peripheral wall 52. For example, the opening portion 52a of the vehicle-body attaching portion 5 is open to (i.e. communicates with) internal spaces of the motor accommodating portion 6 and the control-unit accommodating portion 7 which are attached to the vehicle-body attaching portion 5. A disc-shaped flange portion 53 is formed at a part of an outer circumferential portion of the bottom wall 51 (at a ground-side part of the outer circumferential portion of the bottom wall 51 in the case of FIGS. 1 to 4). The flange portion 53 includes a plurality of fixing bolts 53a by which the flange portion 53 is attached to the vehicle-body panel 90.

In the state where a fixing surface 53b of the flange portion 53 has been fixed to the vehicle-body panel 90, an input rod 13 connected with the piston 12 is disposed to pass through a shaft center side (an axis side) 53c of the flange portion 53 and to extend such that the input rod 13 is not coaxial to the rotor 2a of the motor 2, i.e. does not have the same axis as the rotor 2a. A known rotation-linearity motion conversion mechanism (not shown) is installed in the vehicle-body attaching portion 5. The rotation-linearity motion conversion mechanism converts a rotational motion of the rotor 2a of the motor 2 which is actuated by depression of the brake pedal, into a linear motion of the piston 12 in an axial direction of the piston 12 inside the master cylinder S. Thus, the piston 12 accommodated in a tubular wall 11 of the master cylinder S can linearly move in the axial direction thereof. The rotation-linearity motion conversion mechanism is, for example, a mechanism constituted by properly employing a belt(s), a pulley(s), a gear mechanism and the like.

The input rod 13 which passes through the flange portion 53 of the vehicle-body attaching portion 5 as mentioned above is introduced to a rear side of the flange portion 53 (i.e., introduced to a vehicle interior side), and then is connected with the brake pedal. Moreover, the master cylinder S is equipped with a hydraulic tank 14, an instrument piping portion (not shown), a brake piping portion (not shown) and the like. The hydraulic tank 14 reserves brake fluid which is charged into the tubular wall 11. The instrument piping portion serves to monitor a pressure of the tubular wall 11. The brake piping portion serves to discharge a braking pressure (a pressure of brake fluid) produced by operation of the piston 12 in the tubular wall 11.

The motor accommodating portion 6 includes a tubular partition wall 61 having its bottom. The partition wall 61 includes an opening portion 61a which opens from a rear portion of the partition wall 61 in a rearward direction. For example, the opening portion 61a opens to communicate with an internal space of the vehicle-body attaching portion 5. The motor 2 is accommodated in the partition wall 61. The opening portion 61a of the partition wall 61 is opposed to the opening portion 52a of the vehicle-body attaching portion 5. An output shaft 2c of the rotor 2a of the motor 2 extends to the internal space of the vehicle-body attaching portion 5 such that the output shaft 2c is not coaxial to the master cylinder S, i.e. does not have the same axis as the master cylinder S. That is, the output shaft 2c extends at a location closer to the ceiling beyond the master cylinder S in the case of FIGS. 1 to 4. With such a configuration, the motor accommodating portion 6 is provided to protrude from the vehicle-body attaching portion 5 in the frontward direction. The output shaft 2c of the rotor 2a is connected with the rotation-linearity motion conversion mechanism.

The control-unit accommodating portion 7 is in the form of a box, and accommodates the circuit board 8 which is in the form of flat plate. The control-unit accommodating portion 7 includes a case 71 and a cover 72. The case 71 includes a bottom wall 71a and a peripheral wall 71b. The bottom wall 71a is substantially in the form of a rectangle. The peripheral wall 71b protrudes from the bottom wall 71a to surround four sides of the bottom wall 71a. The peripheral wall 71b is formed with an accommodating opening portion 71d which opens in a protruding direction of the peripheral wall 71b, at a side opposite to the bottom wall 71a. The cover 72 is in the form of a box, and is attached to an opening portion of the case 71 and thereby seals an internal space of the case 71. The bottom wall 71a of the case 71 (i.e. a bottom-side portion of the case 71) is located to face the motor accommodating portion 6 in a direction from a right wheel to a left wheel. Component-mounting surfaces 80a and 80b of the circuit board 8 are provided to extend along the rotor 2a of the motor 2. The bottom wall 71a of the case 71 is formed with a machine-electricity connecting port (not shown) located to face the motor accommodating portion 6 whereas the motor accommodating portion 6 is formed with a machine-electricity connecting port (not shown) located to face the case 71. The machine-electricity connecting port of the case 71 is connected through a machine-electricity connecting section 41 to the machine-electricity connecting port of the motor accommodating portion 6. The machine-electricity connecting section 41 is, for example, constituted by a tubular peripheral wall. Through this machine-electricity connecting section 41, a machine-electricity connection between the motor 2 and the circuit board 8 is established.

For example, the control-unit accommodating portion 7 is provided to protrude from the vehicle-body attaching portion 5, and also is integrated with the vehicle-body attaching portion 5. However, alternatively, the control-unit accommodating portion 7 may be integrated with the master cylinder S or the motor accommodating portion 6 (for example, one side portion of the peripheral wall 71b of the case 71 is integrated with a portion of the master cylinder S or the motor accommodating portion 6 which is close to the vehicle-body attaching portion 5).

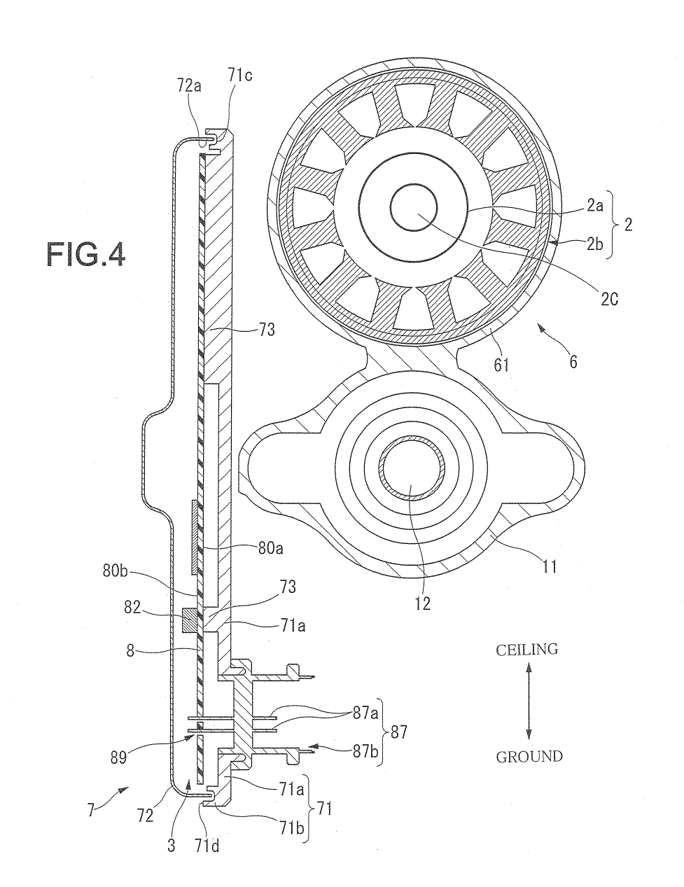

Next, an attaching structure between the case 71 and the cover 72 will now be explained. For example, as shown in FIG. 4, a tip portion of the peripheral wall 71b is formed with a fitting groove 71c. The fitting groove 71c is continuously formed in the tip portion of the peripheral wall 71b along a circumferential direction of the peripheral wall 71b. The cover 72 is formed with a projection portion 72a located to face the fitting groove 71c. The projection portion 72a is fitted through an appropriate sealing material (not shown) into the fitting groove 71c. Hence, adhesion and attaching performance between the case 71 and the cover 72 can be improved. The sealing material is not limited to a particular material. For example, epoxy material, silicon material, acrylic material and the like can be listed as a sealing material having fluidity. From these materials, one or more can be freely selected according to specifications of the control unit 3. Moreover, the sealing material does not need to fill whole of the fitting groove 71c. That is, the sealing material has only to be charged into the fitting groove 71c to a degree necessary to maintain a sealing between the projection portion 72a of the cover 72 and the fitting groove 71c when the projection portion 72a is inserted into the fitting groove 71c.

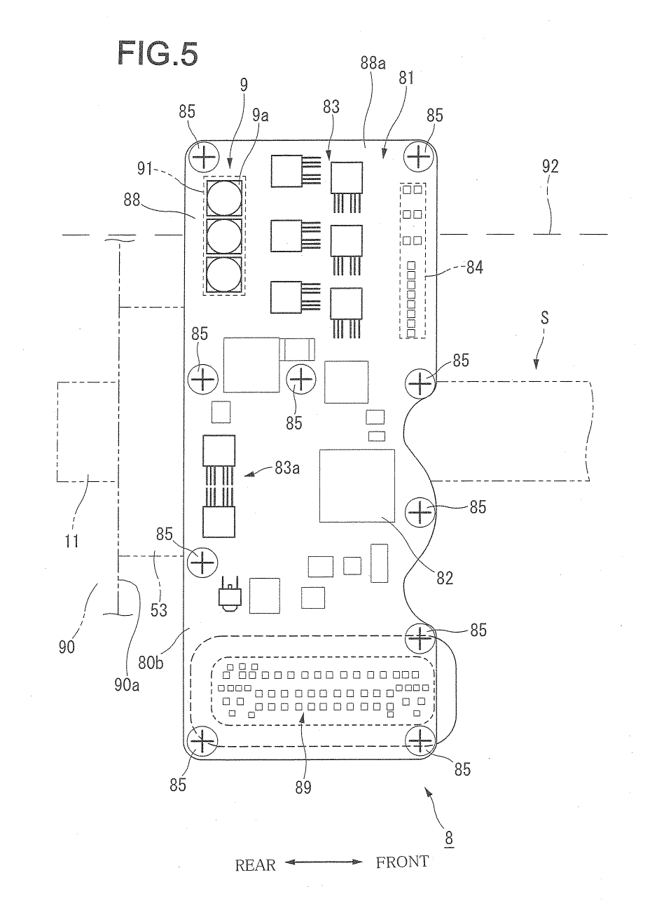

As shown in FIGS. 4 and 5, the circuit board 8 is a board shaped like a flat plate. For example, the circuit board 8 is a thin-plate-shaped board which is made of synthetic resin material. A main circuit 81 is constituted, for example, on the component-mounting surface 80a and/or the component-mounting surface 80b which are both surfaces of the circuit board 8. The main circuit 81 includes a control section (such as a microcomputer) 82, a drive element (such as MOSFET, six elements in the case of FIG. 5) 83 and the like. The control section 82 outputs at least a control signal of the motor 2. The drive element 83 outputs a drive signal based on the control signal, to a conducting terminal (not shown). This conducting terminal is connected with a machine-electricity connecting hole group 84 of the circuit board 8. Accordingly, the main circuit 81 functions as an inverter circuit of the motor 2. The conducting terminal supplies the drive signal received from the drive element 83, to the motor 2. For example, the conducting terminal is connected through the above-mentioned machine-electricity connecting section 41 to the motor 2. Moreover, as shown in FIG. 5, an electrolytic condenser 9 which is a large-size electronic component for the drive element 83 is mounted on the component-mounting surface 80a (and/or the component-mounting surface 80b). In the case of FIG. 5, three electrolytic condensers 9 are mounted in a mounting region 91 of the component-mounting surface 80a (and/or the component-mounting surface 80b). Each of the three electrolytic condensers 9 is attached through a vibration-resistant supporting seat 9a to the mounting region 91. Moreover, a relay circuit 83a which is a structural component of a filter electronic circuit is mounted. As the other components, for example, a shunt resistor, a common-mode coil and a normal-mode coil are mounted. These components mounted on the component-mounting surface 80a (and/or the component-mounting surface 80b) can electrically communicate with the main circuit 81.

Various types can be employed as a method of fastening the circuit board 8 in the control-unit accommodating portion 7. For example, there is the following fastening structure. That is, fixing columns (or poles, not shown) are formed at portions of the case 71 which face a peripheral edge portion and a central portion of the circuit board 8. The circuit board 8 includes board-attachment portions 85 at locations opposed to the fixing columns. Each of the board-attachment portions 85 is formed with a fixing hole (not shown) into which the fixing column can be inserted. An attaching member (such as a screw) is inserted through each of the fixing hole and is attached (i.e., screwed in the case that the attaching member is a screw) into the fixing column, so that the circuit board 8 is fixed to the case 71.

Between the circuit board 8 and the case 71 or the cover 72 of the control-unit accommodating portion 7, a desired clearance (whose details omitted) may be provided for purpose of suppressing vibrations and/or shocks that are transmitted from the control-unit accommodating portion 7 to the circuit board 8. Moreover, an elastic member or the like may be interposed in the clearance between the circuit board 8 and the case 71 or the cover 72. Furthermore, a protruding portion 73 which protrudes from the case 71 or the cover 72 may be formed in the clearance between the circuit board 8 and the case 71 or the cover 72. Furthermore, a thermally-conductive member (not shown) may be interposed in the clearance between the circuit board 8 and the case 71 or the cover 72. For example, by interposing a sheet-shaped thermally-conductive member or a known heat-radiating material (such as a heat-radiating grease and a heat-radiating adhesive), a thermal conductivity from the circuit board 8 to the control-unit accommodating portion 7 is improved so as to enhance a heat radiation performance of the control-unit accommodating portion 7.

The case 71 and the cover 72 are connected with each other, for example, by use of fastening means 74 (such as screw and nut). As shown in FIG. 4, a connector 87 includes, for example, a plurality of terminals 87a and a fitting portion 87b. The plurality of terminals 87a pass through the bottom wall 71a of the case 71, and thereby connect the main circuit 81 of the circuit board 8 with an external device (not shown). In the case of FIGS. 4 and 5, the plurality of terminals 87a are attached to a connecting hole group 89 of the circuit board 8. The fitting portion 87b is provided to protrude from an outer peripheral portion of the bottom wall 71a of the case 71 in a thickness direction of the bottom wall 71a and to surround the plurality of terminals 87a. The fitting portion 87b is fitted into or over a connector of the external device (not shown).

<One Example of Circuit Board 8>

As shown in FIG. 5, on the circuit board 8, the drive elements 83 are located between the machine-electricity connecting hole group 84 and the mounting region 91 in which the electrolytic condensers 9 are mounted. Moreover, the mounting region 91 in which the electrolytic condensers 9 are mounted is located in a vehicle-body-attaching-portion-side portion 88 of a peripheral portion (outer circumferential edge portion) 88a of the component-mounting surface 80b. That is, the electrolytic condensers 9 are attached to the vehicle-body-attaching-portion-side portion 88 of the circuit board 8 which is close to the vehicle-body panel 90. Hence, swings due to vibrations caused by a drive of the motor 2 and a running of the vehicle or the like are suppressed as compared with a case where large-size electronic components are mounted at a location away from the vehicle-body panel 90 (e.g., a case where the large-size electronic components are mounted at a location near the machine-electricity connecting hole group 84 on the component-mounting surface 80b, not shown).

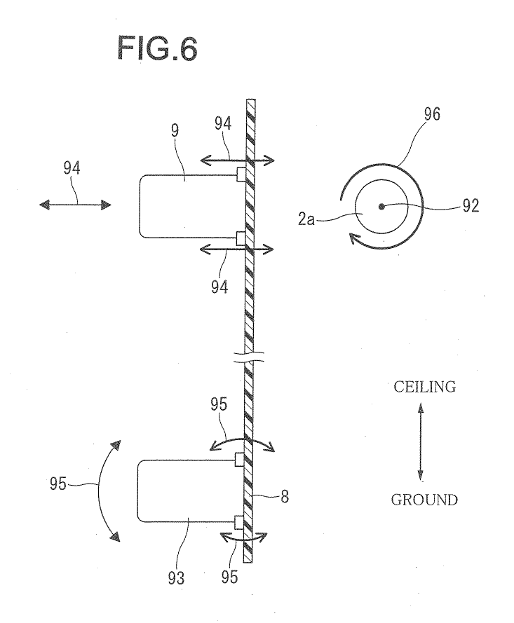

As shown in FIG. 5, the electrolytic condensers 9 and the mounting region 91 thereof are located on or near a projection line (not shown) of an axis 92 of the rotor 2a on the component-mounting surface 80b (and/or the component-mounting surface 80a). That is, the electrolytic condensers 9 and the mounting region 91 thereof overlap with a projection of the rotor 2a as viewed in a direction perpendicular to the component-mounting surface 80b. As shown in FIG. 6, when the rotor 2a of the motor 2 rotates in a direction shown by an arrow 96 of FIG. 6, a large-size electronic component 93 mounted at the location far away from the projection line of the axis 92 on the component-mounting surface 80b (e.g., a large-size electronic component 93 attached near the connecting hole group 89) tends to swing (or oscillate) as shown by arrows 95 of FIG. 6. On the other hand, the electrolytic condenser 9 in this embodiment tends to swing (or oscillate) in a thickness direction of the circuit board 8 as shown by arrows 94 of FIG. 6 even if the electrolytic condenser 9 swings when the rotor 2a rotates in the direction shown by the arrow 96. Hence, each electrolytic condenser 9 in this embodiment is inhibited from swinging as compared with the large-size electronic component 93, and is prevented from being damaged, e.g. detached from the circuit board 8.

The electrolytic condensers 9 in this embodiment are mounted at an upper portion of the circuit board 8 with respect to an upper-lower direction of the vehicle body. Hence, heat generated by the electrolytic condensers 9 is easy to radiate through the bottom wall 71a of the case 71 and the like.

Although the invention has been described above with reference to certain embodiments and examples of the invention, the invention is not limited to the embodiments and examples described above. Modifications and variations of the embodiments and examples described above will occur to those skilled in the art in light of the above teachings.

This application is based on a prior Japanese Patent Application No. 2014-192081 filed on Sep. 22, 2014. The entire contents of this Japanese Patent Application are hereby incorporated by reference.

The scope of the invention is defined with reference to the following claims.

What is claimed is:

1. An electronic control apparatus comprising:
an electric motor including a rotor and a stator;
a circuit board configured to drivingly control the electric motor; and
a housing unit accommodating the electric motor and the circuit board,
wherein a vehicle-body attaching portion of the housing unit is attached and fixed to a vehicle body, the vehicle-body attaching portion being located on one side of the rotor with respect to an extending direction of the rotor,
at least one of both surfaces of the circuit board is a component-mounting surface,
the circuit board is fixed to the housing unit in a state where the both surface of the circuit board extend along the rotor of the electric motor, and
a large-size electronic component is mounted on a vehicle-body-attaching-portion-side portion of a peripheral portion of the component-mounting surface which is close to the vehicle-body attaching portion.

2. The electronic control apparatus according to claim 1, wherein
a region on which the large-size electronic component is mounted is located on a projection line of the rotor on the component-mounting surface.

3. The electronic control apparatus according to claim 1, wherein
the vehicle-body-attaching-portion-side portion is located at an upper portion of the component-mounting surface with respect to an upper-lower direction of the vehicle body.

4. The electronic control apparatus according to claim 1, wherein
the large-size electronic component is attached through a vibration-resistant supporting seat to the component-mounting surface.

5. The electronic control apparatus according to claim 1, wherein
the region on which the large-size electronic component is mounted overlaps with the rotor as viewed in a direction perpendicular to the component-mounting surface, and
the region is located at an edge portion of the component-mounting surface which is close to the vehicle-body attaching portion.
